(19) United States
(12) Patent Application Publication
(10) Pub. No.: US 2013/0055157 A1
(43) Pub. Date: Feb. 28, 2013

(54) SCHEDULE MANAGING METHOD AND APPARATUS

(71) Applicants: Mi Jung PARK, Gyeonggi-do (KR); Yu Mi AHN, Seoul (KR); Tae Yeon KIM, Seoul (KR)

(72) Inventors: Mi Jung PARK, Gyeonggi-do (KR); Yu Mi AHN, Seoul (KR); Tae Yeon KIM, Seoul (KR)

(73) Assignee: SAMSUNG ELECTRONICS CO., LTD., Gyeonggi-do (KR)

(21) Appl. No.: 13/553,994

(22) Filed: Jul. 20, 2012

(30) Foreign Application Priority Data
Aug. 31, 2011 (KR) 10-2011-0088000

(51) Int. Cl. G06F 3/048; G06F 3/041

(52) U.S. Cl. 715/810

(57) ABSTRACT

A schedule managing method and apparatus in which the method preferably includes: displaying on a display a deadline setting icon for setting a deadline of at least one schedule; selecting the deadline setting icon; and setting the deadline of the schedule in response to the selection of the deadline setting icon. The schedule managing apparatus preferably includes: a display unit for displaying a deadline setting icon for setting a deadline of at least one schedule; a pointer for selecting the deadline setting icon displayed by the display unit; and a controller for io setting the deadline of the schedule in response to the selection of the deadline setting icon.

### CLAIM OF PRIORITY

Applicant claims the right of the priority under 35 U.S.C. §119 from Korean Patent Application No. 10-2011-0088000 filed Aug. 31, 2011 in the Korean Intellectual Property Office, the contents of which are hereby incorporated by reference in its entirety.

### BACKGROUND OF THE INVENTION

1. Field of the Invention

The present invention relates to a schedule managing method and apparatus. More particularly, the present invention relates to a schedule managing method capable of setting a deadline of a schedule and an apparatus thereof.

2. Description of the Related Art

Due to various new designs and applications stimulating consumer demand, a market for portable terminals has rapidly grown. In particular, unlike an existing portable phone using only given functions from the manufacturer, a smart phone has the capability to down-load and install various applications for taking a photograph or photographing a moving image, playback of audio and video, on-line games, watching broadcasting, social network service from an on-line market, etc., just to name of the possible applications (i.e. “apps” for relatively short applications).

More recently, manufactured portable terminals tend to include a touch screen and provide,s a method for managing a schedule of the user through the touch screen. However, in a conventional method for managing a schedule, it is difficult to edit a registered schedule.

In particular, in the conventional method for managing a schedule, for example, in order to change a deadline of a registered schedule, the user needs to move to a screen for editing a schedule (typically after first displaying the schedule) and then newly inputting a date on an editing screen after selecting an edit option subsequent to viewing the schedule. This procedure is very complicated especially since the user often io manages various schedules and a deadline frequently changes.

### SUMMARY OF THE INVENTION

The present invention provides a schedule managing method for selecting a displayed deadline setting icon that allows the user to easily set a deadline of a schedule, and an apparatus thereof.

In accordance with an exemplary aspect of the present invention, a schedule managing method preferably includes: displaying a deadline setting icon for setting a deadline of at least one schedule; sensing by the display the selection of the deadline setting icon; and setting the deadline of the schedule in response to the selection of the deadline setting icon.

In accordance with another exemplary aspect of the present invention, a schedule managing apparatus preferably includes: a display unit for displaying a deadline setting icon for setting a deadline of at least one schedule; a pointer for selecting the deadline setting icon displayed by the display unit; and a controller for setting the deadline of the schedule in response to the selection of the deadline setting icon.

### BRIEF DESCRIPTION OF THE DRAWINGS

The exemplary above features and advantages of the present invention will become more apparent from the following detailed description in conjunction with the accompanying drawings, in which:

FIG. 1 is a block diagram illustrating a configuration of a schedule managing apparatus according to an exemplary embodiment of the io present invention;

FIGS. 2 to 6 are non-limiting examples of views illustrating some of the many ways a user interface for setting a deadline according to the present invention may appear on a portable terminal;

FIG. 7 is a flowchart providing illustrating exemplary operation of a schedule managing method according to an exemplary embodiment of the present invention;

FIG. 8 is a flowchart illustrating exemplary operation of a schedule managing method according to another exemplary embodiment of the present invention; and

FIG. 9 is a flowchart illustrating exemplary operation of a schedule managing method according to a further exemplary embodiment of the present invention.

### DETAILED DESCRIPTION

A schedule managing method and apparatus according to exemplary embodiments of the present invention are described herein with reference to the accompanying drawings in detail. The same reference numbers are used throughout the drawings to refer to the same or like parts. Detailed descriptions of well-known functions and structures incorporated herein may be omitted to avoid obscuring appreciation by a person of ordinary skill in the art of the subject matter of the present invention with a detailed description of such well-known functions and structures.

A schedule managing apparatus according to the present invention comprises a device including a pointer, which is applicable to various information communication devices and multi-media devices such as portable phones, smart phones, tablet PCs, handheld PCs, Portable Multimedia Players (PMP), Personal Digital Assistants (PDA), music players (e.g., MP3 player), and portable game terminals, digital broadcasting players, and application devices thereof. The pointer preferably includes a write pen, a mouse, a touch pad, a track ball, and a touch screen. Hereinafter, it is assumed that the schedule managing apparatus is a smart phone and the pointer is a touch screen.

The schedule managing apparatus of the present invention preferably includes an application or a widget that may manage a schedule of a user. In this particular case, the widget comprises a mini application that allows a user to directly use contents or functions without through an application. For example, there may be an application such as weather, calendar, calculator, and news as an example of a widget. Hereinafter, it is assumed in the present invention that the application includes the widget. The schedule managing application may be downloaded from an on-line market. A schedule managing application provides a user interface function that allows a user to easily advance or extend a deadline set in a schedule, namely, a D-day. Further, the schedule managing application provides a re-alarm function of a schedule.

In other words, a schedule managing application of the present invention provides a function that may alarm a deadline of a schedule in an alarm time set in the schedule, and re-alarm the deadline according to the request of the user later, and change the deadline of the schedule to another date.

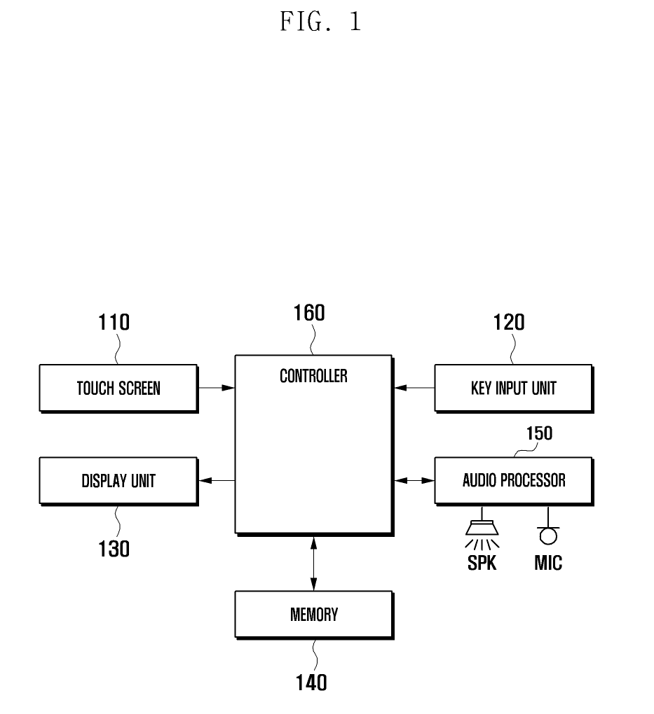

FIG. 1 is a block diagram illustrating a configuration of a schedule managing apparatus according to an exemplary embodiment of the present invention.

Referring now to FIG. 1, a schedule managing apparatus of the present invention may preferably include a touch screen 110, a key input unit 120, a display unit 130, a memory 140, an audio processor 150, a speaker SPK, a microphone MIC, and a controller 160.

The schedule managing apparatus having a construction as mentioned above displays a home screen including icons indicating various applications, respectively. If an icon of the schedule managing application is displayed on the home screen, the schedule managing apparatus performs a corresponding application to display the schedule list. Moreover, the schedule managing apparatus displays detailed information and deadline information with respect to respective schedules. Furthermore, the schedule managing apparatus displays a deadline setting icon with respect to the respective schedules. If the deadline setting icon is touched by the user (or selected by any type of pointer), the schedule managing apparatus advances or extends a deadline of a corresponding schedule by one day. For example, the deadline of the schedule is set to today, the user touches a deadline setting icon of the corresponding schedule to delay the deadline until tomorrow. Optionally, a confirmation prompt may in case the user inadvertently touched the screen or touched the wrong icon. When the deadline of the schedule is tomorrow or some subsequent date, the user touches a deadline setting icon of the corresponding schedule to extend or advance the deadline by one day. In this case, the deadline setting icon contains an icon for advancing the deadline by one day and an icon for extending the deadline by one day. When the deadline of the schedule is not set or lapses, the user may touch a deadline setting icon of the corresponding schedule to determine the deadline as today. Moreover, the schedule managing apparatus may alarm a deadline of the corresponding schedule at a designated alarm time and perform the schedule managing application to display detailed information of the corresponding schedule including the deadline information and the deadline setting icon. Hereinafter, respective constructions of the schedule managing apparatus will be described in detail.

The touch screen 110 senses the touch event and generates and transfers a signal corresponding to the particular type of touch event in response to a touch of the user with respect to a certain point of the screen to the controller 160. The controller typically includes a processor or microprocessor that is configured for operation. The touch event may be classified into, for example, touch, tap, double tap, press, drag, drag & drop, flick, and drag & flick according to its operation. In this case, the touch is an operation that a user pushes one point. The tap is an operation that the user separates, namely, drops a finger from a corresponding point without movement of the finger after touching one point. The double tap is an operation that continuously taps one point of the screen twice. The press is an operation that separates a finger from a corresponding point without movement of the finger after touching it longer than the tap. The drag is an operation that moves a finger in a predetermined direction in a state that the user touches one point. The drag & drop is an operation that separates a finger after dragging the finger. The flick is an operation that separates a finger after moving the finger at rapid speed like flipping. Here, the drag is referred to as ‘scroll’. The drag & flick is an operation that drags a finger and flicks the finger at a predetermined time point, that is, an operation continuously performing the drag and the flick in a state that the finger contacts with the touch screen 110. The controller 160 may distinguish the flick from the drag based on moving speed. The controller 160 controls the display unit 130 in response to the touch event. All of these operations are used in touch screens for current smart phone technology. A person of ordinary skill in the art understands and appreciates that additional touch/gesture functionality not disclosed herein above could also be used in conjunction with the presently claimed invention. For definitive purposes, the term “contacts” is to be interpreted in the appended claims that all of the above described ways of touch, tap, press, flick, drag with a finger, stylus or other types of pointing devices should be included in such a definition.

With continued reference to FIG. 1, the key input unit 120 is configured by a plurality of keys for operating the schedule managing apparatus, and transfers a key signal to the controller 160. The controller 160 controls the display unit 130 in response to the key signal. The key signal may be divided into, for example, a power on/off signal, a volume control signal, and a screen on/off signal.

The display unit 130 converts image data received from the controller 160 into an analog signal, and displays the analog signal. Stated another way, the display unit 130 displays various screens such as a lock screen, a home screen, and an application execution screen according to the use of the schedule managing apparatus. In this particular exemplary case, the lock screen is an image displayed when a power on signal for the display unit 130 is generated. For example, if a trace of the drag is identical with a preset trace, the controller 160 changes an image displayed on the screen from a lock screen to a home screen or an application execution screen. The home screen is an image including a plurality of icons for executing an application. If the user touches an icon, the controller 160 may execute a corresponding application and change a displayed image from the home screen to the application execution screen.

Further, the display unit 130 may be configured by a flat panel display such as, for example, a Liquid Crystal Display (LCD) or an Organic Light Emitted Diode (OLED). Any other type of thin-film technology display may also be used. The display unit 130 may include a 3D implementing unit for displaying a left image and a right image, and allowing a user to feel depths of the left and right images. As I known to those skilled in the art, a 3D implementing scheme is typically divided into a spectacle scheme and a non-spectacle scheme. The spectacle scheme preferably includes a color filter scheme, a polarizing filter scheme, and a shutter glass scheme. The non-spectacle scheme preferably includes a lenticular lens scheme and a parallax barrier scheme.

The memory 140 stores a screen to be outputted on the display unit 130, in particular, an execution screen of a schedule managing application as well as an application necessary for a function operation according to an exemplary embodiment of the present invention. Further, the memory 140 may store a key map or a menu map for an operation of the touch screen 110. In this case, the key map and the menu map may comprise various forms. In other words, the key map may become a keyboard map, a 3*4 key map, a Qwerty key map, a Dvorak key map, or a control key map, etc., for controlling a currently executed application. Further, the menu map may become a menu map for controlling a currently executed application.

The memory 140, which may comprise a machine readable non-transitory medium, may chiefly include a program area and a data area. The program area may store machine executable code such as an operating system (OS) for booting the schedule managing apparatus and operating the foregoing constructions, and an application program for supporting various user functions, for example, a user function for supporting a call function, a web browser for accessing an Internet server, an MP3 user function for playing other sound sources, an image output function for playing photographs, and a moving image playback function, etc. In particular, the program area of the present invention can store the foregoing schedule managing application. The data area comprises an area for storing data created by the controller 160, in particular, a schedule according to the use of the schedule managing apparatus, and may store an image (e.g., map) associated with the schedule, deadline information, alarm time, a preset value indicating the presence of the use of a re-alarm, and the number of alarms of a schedule to which re-alarm is previously set, and detailed information thereof.

The audio processor 150 performs a function that includes transmitting an audio signal, in particular, an alarm signal input from the controller 160 to the speaker SPK, and transmits an audio signal such as a voice input from the microphone MIC to the controller 160. Put another way, the audio processor 150 converts voice/sound data into an audible sound through a speaker SPK under the control of the controller 160. The audio processor 150 typically converts an audio signal such as a voice received from the microphone MIC into a digital signal, and transfers the digital signal to the controller 160.

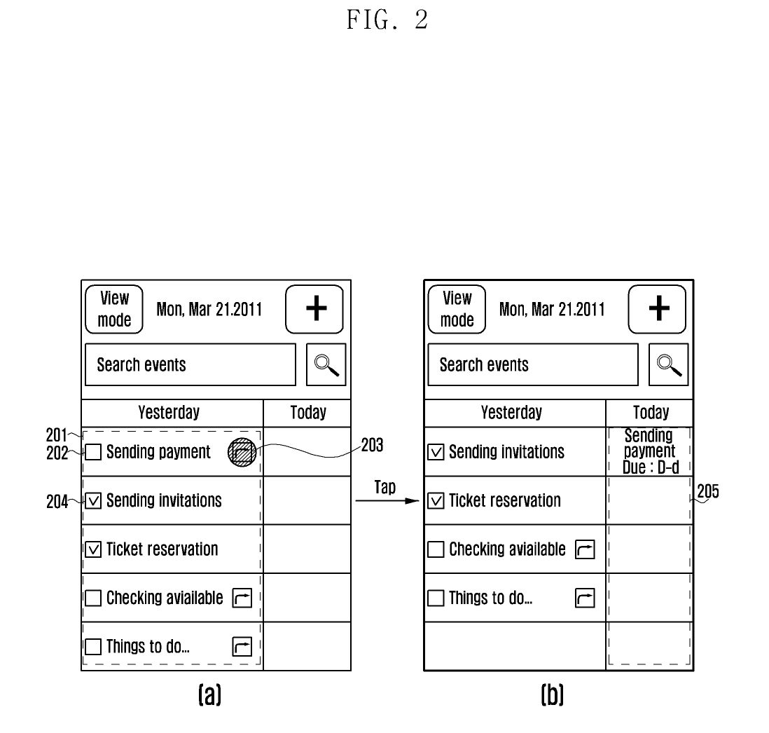

The controller 160 preferably controls an overall operation and signal flow between internal blocks of the schedule managing apparatus. In particular, the controller 160 performs a number of functions including a function for displaying a schedule, a deadline, and a deadline setting icon; a function for setting a deadline of a schedule in response to selection of a deadline setting icon; a function for alarming a deadline of a corresponding schedule at an alarm time; and a function for again alarming the deadline after a predetermined time in response to a request of the user while alarming the deadline. The functions of the controller 160 will now be described with reference to FIGS. 2 to 6 in detail.

FIGS. 2 to 6 are views illustrating a user interface for setting a deadline according to the present invention. First, a controller 160 performs a function for easily changing a due data from yesterday to today (as shown but could be or some other day). In detail, referring to FIG. 2(a), if an icon displaying a schedule the deadline of which lapses by one day is touched from icons displayed on a home screen, the controller 160 controls the display unit 130 to display a schedule list 201 the deadline of which has lapsed by one day. In this case, the displayed schedule list 201 includes a check box 202 corresponding to each schedule and an icon 203 for changing a deadline to today. If the user taps the check box 202, the touch screen 110 transfers a touch event associated therewith to the controller 160. Accordingly, the controller 160 controls the display unit 130 to eliminate a corresponding deadline setting icon 203 disappear.

Conversely, if the user taps a checked check box 204, the controller 160 releases the check and controls the display unit 130 to display a deadline setting icon. In other words, the user may change a deadline of a non-checked schedule. From a position of the user, the checked schedule is a schedule that has been previously performed or is unnecessary to be checked longer. In the meantime, if the user taps the deadline setting icon 203, the controller 160 controls the display unit 130 to eliminate a corresponding schedule from the schedule list. As shown in FIG. 2(b), the controller 160 controls the display unit 130 to display a schedule list 205 the deadline of which is today including a corresponding schedule. If a drag occurs on a region on which a schedule list 201 the deadline of which lapses by one day is displayed, the touch screen 110 transfers a touch event associated therewith to the controller 160. Accordingly, the controller 160 controls the display unit 130 to eliminate an existing displayed schedule. Further, the display unit 130 displays a new schedule. For example, if the user drags to a left side, the schedules disappear from the upper most schedule and a new schedule is displayed at the lower most part. Further, if the user drags from a right side to a left side, all existing displayed schedules disappear and a new schedule is displayed.

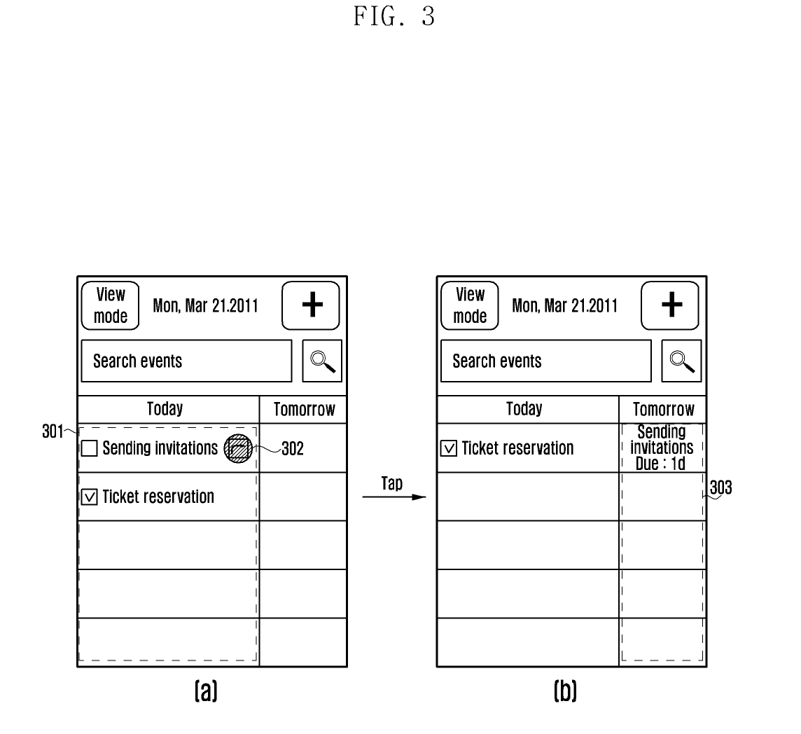

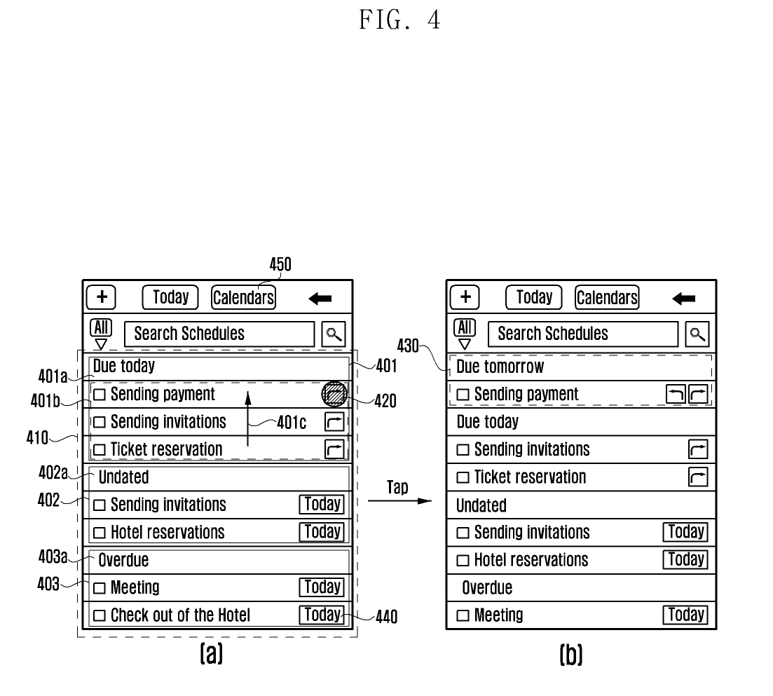

With reference to FIG. 3(a), the controller 160 performs a function capable of easily changing the deadline from today to tomorrow. In more detail, FIG. 3(a) shows the controller 160 of FIG. 1 controls the display unit 130 to display a schedule list 301 the deadline of which is today. If the user taps a deadline setting icon 302, the touch screen 110 transfers a touch event associated therewith to the controller 160. Accordingly, the controller 160 controls the display unit 130 to eliminate a corresponding schedule from the schedule list 301. As shown in FIG. 3(b), the controller 160 controls the display unit 130 to display the schedule list 303 the deadline of which is tomorrow including the corresponding schedule of today (e.g. ticket reservation). In the meantime, now referring to FIG. 4(a), if the schedule managing application of the present invention is executed, the controller 160 controls the display unit 130 to display an execution screen including the schedule list 410. In this case, the schedule list 410 may preferentially include a schedule list a deadline 401a which is today.

Further, if a display space is allowed, a schedule list 402 the deadline (402a) of which is not set and a schedule list 403 the deadline 403(a) of which lapses may be displayed. Moreover, if a display space is further allowed, a schedule list the deadline of which is after tomorrow may also be displayed. Further, schedule lists classified by deadlines may include an indicator that allows a user to recognize when is the deadline. In other words, reference numeral 401a represents an indicator the deadline of which is due today, reference numeral 403a represents an indicator the deadline of which indicates lapses, and reference numeral 402a represents an indicator the deadline of which is not set (i.e. undated). Meanwhile, if the user taps an icon 420 for changing a deadline to due tomorrow, the controller 160 controls the display unit 130 to eliminate a corresponding schedule from a schedule list 401 the deadline of which is due today. As shown in FIG. 4(b), the controller 103 controls the display unit 130 to display the schedule list 430 a deadline of which is due tomorrow including a corresponding schedule.

The controller 160 performs a function that may set a deadline of a schedule the deadline of which is not set or lapses to today. Referring back to FIG. 4(a), a controller 160 may control the display unit 130 to display an icon 440 for determining a deadline of a schedule the deadline of which is not set or lapses to today. If the icon 440 is tapped, the controller 160 controls the display unit 130 to eliminate a corresponding schedule from a corresponding schedule list. The controller 160 controls the display unit 130 to display a schedule list 401 the deadline of which is due today including the corresponding schedule.

The controller 160 may change a schedule list to be displayed on a screen in many other ways than shown. For example, referring to FIG. 4(a), if a downward drag starting from a region on which an indicator 401a occurs, the controller 160 controls the display unit 140 to display a schedule list the deadline of which is after tomorrow at an upper most part. The controller 160 controls a display unit 130 to eliminate the schedule list 403 the deadline of which has lapsed and is overdue. As shown in FIG. 4(a), if a drag occurs to a left side 401c in a region 401b on which a schedule a deadline of which is due today, a touch screen 110 transfers a touch event associated therewith to the controller 160. Accordingly, the controller 160 eliminates a schedule at an upper most part in a region 401 b and instead displays a new schedule at an lower most part.

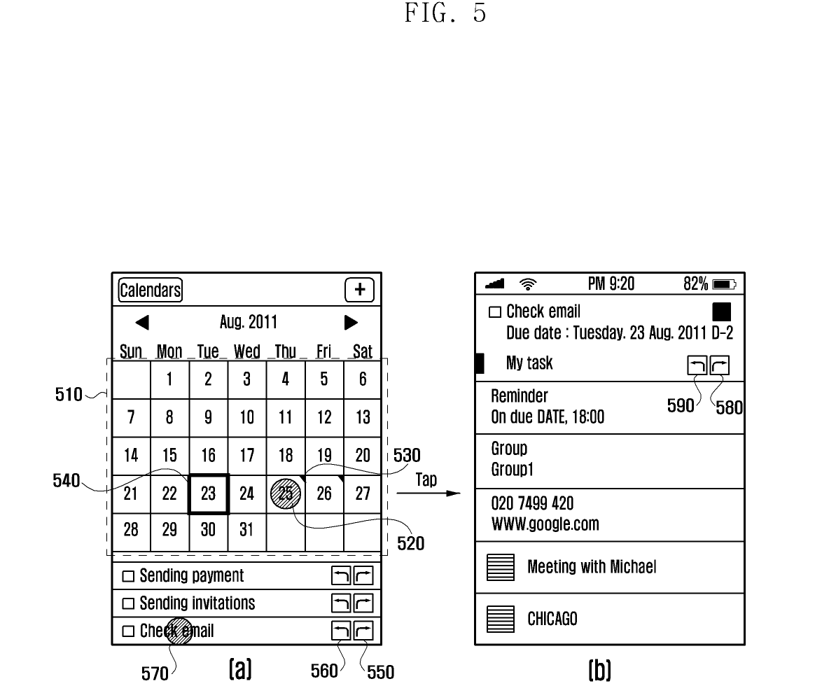

In another exemplary embodiment, referring to FIG. 5(a), a display unit 130 displays this month. For example, if an indicator 450 of FIG. 4(a) for displaying a calendar is tapped, the touch screen 110 transfers a touch event associated therewith to the controller 160. Accordingly, the controller 160 controls the display unit 130 to display the calendar 510. The controller 160 displays an indicator 530 that allows a user to recognize the presence of a schedule at a date having a schedule of displayed dates. If the date having the schedule is tapped, the controller 160 controls the display unit 130 to display schedules of a corresponding date under the calendar 510. Meanwhile, reference numeral 540 is an indicator indicating today.

Subsequently, the controller 160 performs a function that can easily advance or extend the deadline by one day or more. In detail, referring back to FIG. 5(a), if, for example, an icon 550 for extending a deadline by one day or an icon 560 for advancing the deadline by one day is tapped, the controller 160 controls the display unit 130 to eliminate a corresponding schedule. Further, the controller 160 changes a deadline of a schedule to a corresponding date. Further, a title of a schedule is tapped (570 of FIG. 5(a)), as shown in FIG. 5(b), the controller 160 controls a display unit 130 to display detailed information of a corresponding schedule. Referring now back to FIG. 5(b), if an icon for extending the deadline or an icon 590 for advancing the deadline is tapped, the controller 160 changes the deadline of the schedule to a corresponding date by the number of times of taps.

When the deadline is extended by greater than a predetermined set number of times, the controller 160 then performs a function for guiding it to the user. In detail, referring to FIG. 5(b), if the user taps a deadline extending icon 580 by greater than the preset number, the controller 160 may control the display unit 130 to overlap a pop-up on a detailed information screen. In this case, the pop-up comprises a screen guiding that the deadline is extended by greater than the predetermined number, and the set number comprises a value that the user can control. In other words, the controller 160 provides an option that allows the user to control the number of times designated as a default to the user. The controller 160 may display the pop-up and controls the speaker SPK to output a guide sound. When the deadline is extended by greater than the preset number of times, the controller 160 may control the display unit 130 to distinguish a corresponding schedule from another schedule and to display the corresponding schedule. For example, it is assumed that the pop-up includes contents indicating that “a deadline is extended by three days. Do you want to extend the deadline” and a “Yes/No” button. If the user taps a “Yes” button, the controller 160 controls the display unit 130 to eliminate the pop-up. Furthermore, the controller 160 may control the display unit 130 to display a title of a corresponding schedule the deadline of which is extended longer than a set value distinguished from that of another schedule thickly or to have a different color.

When the deadline is also shortened by greater than the preset number of times, the controller 160 performs a function for guiding the shortened deadline to the user. For example, the controller 160 may control the display unit to display a title of a schedule shortened by greater than the preset number distinguished from another schedule. Thus, the controller is configured to extend or shorten a deadline when the schedule is extended or shortened by the display sensing a number of touches or taps of the display screen that are greater (larger in quantity) than a preset number of times the touches or taps are configured in the controller as being sensed for selection of the deadline setting icon.

Moreover, the controller 160 may perform a function of limiting the extending and shortening of the deadline. In detail, referring to FIG. 5(b), if the user taps a deadline extending icon 580 by greater than a preset number, the controller 160 may eliminate the deadline extending icon 580 not to extend the deadline any longer. The same results were obtained on shortening the deadline.

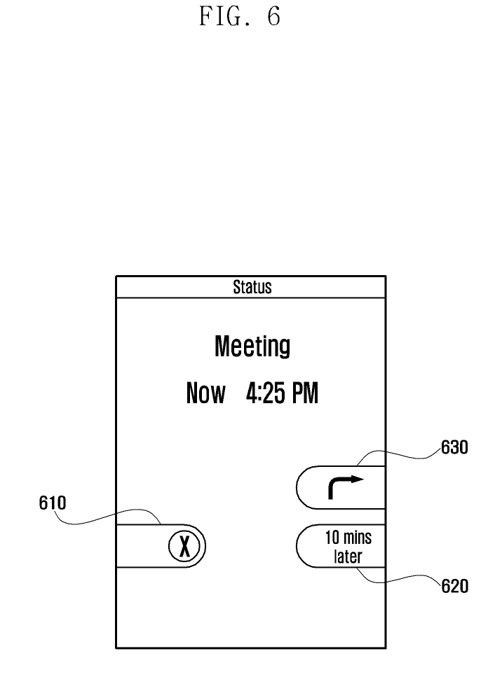

Next, the controller 160 performs a function for alarming a deadline of a schedule and a function for re-alarming the deadline of the schedule. In detail, referring to FIG. 6, if an alarm time of the schedule comes, the controller 160 controls the display unit 130 to display an alarm screen of a corresponding schedule. As shown in FIG. 6, the alarm screen preferably includes an icon 610 for terminating an alarm, an icon 620 for re-alarming after a set time, for example, 10 minutes, and an icon 630 for extending a deadline of a corresponding schedule by one day. If a re-alarm icon 620 is tapped or dragged from the alarm screen, the controller 160 re-alarms after a preset time. Further, the controller 160 performs a function extending a deadline of a corresponding schedule while alarming (i.e. setting an alarm for) the schedule. Referring back to FIG. 6, if an icon for extending the deadline by one day is tapped, the controller 160 changes the deadline of a schedule to a corresponding date that is one day later than a current date.

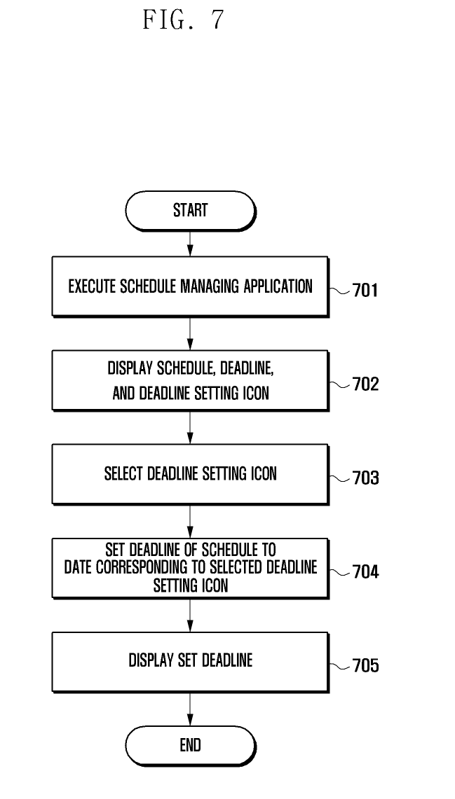

FIG. 7 is a flowchart illustrating exemplary operation of a schedule managing method according to an exemplary embodiment of the present invention. Referring now to FIG. 7, at (701) if an icon for executing a schedule managing application of icons displayed on a home screen is touched by a user, a controller 160 executes a corresponding application. Next, at (702) the controller 160 controls a display unit 130 to display an application execution screen including a schedule, a deadline, and a deadline setting icon. In this case, the application execution screen may become an execution screen as shown in FIGS. 2 to 5. The deadline setting icon includes an icon for determining a deadline as today when a deadline of a corresponding schedule is not set or lapses. Further, the deadline setting icon preferably includes an icon for changing a deadline of a corresponding schedule to tomorrow when the deadline of a corresponding schedule is today. Moreover, the deadline setting icon preferably includes an icon for advancing a deadline of a corresponding schedule and an icon for extending a deadline of a corresponding schedule when the deadline of a corresponding schedule is after tomorrow.

If a displayed deadline setting icon is selected by a user, at (703) the touch screen 110 transfers a touch event associated therewith to the controller 160. Accordingly, at (704) the controller 160 detects the selection of the deadline setting icon, sets a deadline of a schedule to a date corresponding to a selected deadline setting icon, and stores the set deadline information in a memory 140. At (705) the controller 160 may control the display unit 310 to display the set deadline.

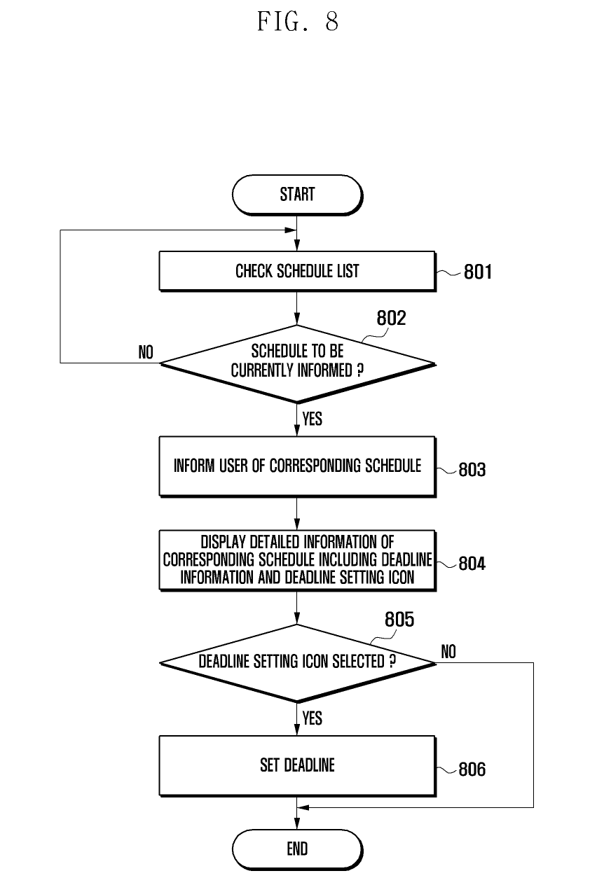

FIG. 8 is a flowchart illustrating exemplary operation of a schedule managing method according to another exemplary embodiment of the present invention. Referring now to FIG. 8, at (801) a controller 160 checks a stored schedule list. At (802) when there is a schedule to be currently informed in a schedule list, then at (803) the controller 160 informs the user of a corresponding schedule through a speaker “SPK”.

With continued reference to FIG. 8, at (804) the controller 160 controls the display unit 130 to display a corresponding schedule. For example, as shown in FIG. 5(b), the controller 160 may control the display unit 130 to display detailed information of a corresponding schedule including deadline information and a deadline setting icon. As shown in FIG. 6, the controller 160 may display an alarm screen including a title, an alarm time, and a deadline setting icon of a schedule. When at (805) the deadline setting icon is selected, the touch screen 110 transfers a corresponding touch event to the controller 160. Accordingly, at (806) the controller 160 changes a deadline of a corresponding schedule to another date and stores the changed deadline information in a memory 140.

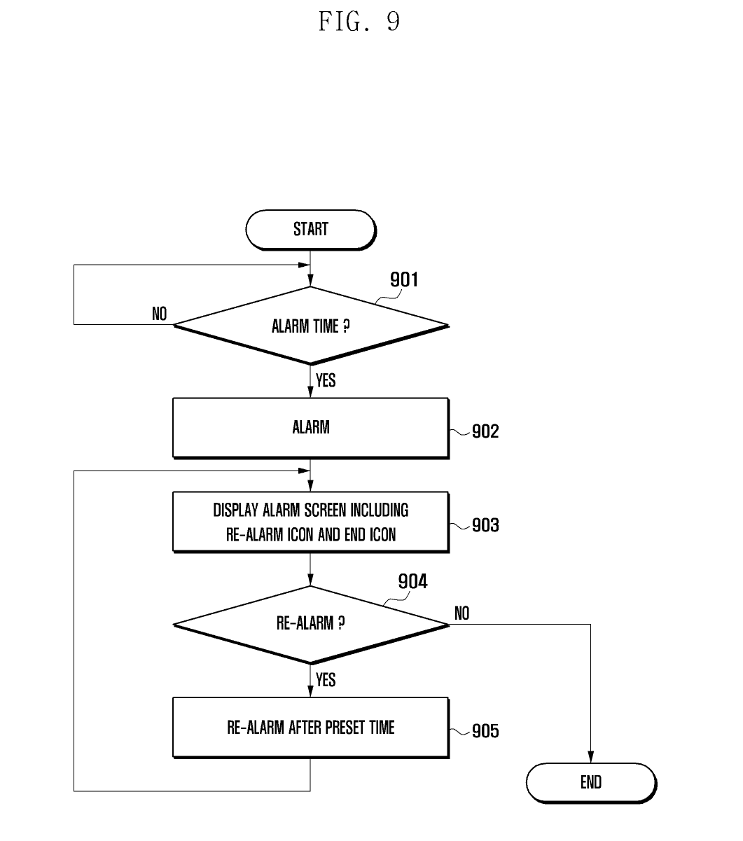

FIG. 9 is a flowchart illustrating exemplary operation of a schedule managing method according to a further exemplary embodiment of the present invention.

Referring now to FIG. 9, at (901) a controller 160 determines whether a current time is an alarm time. In other words, the controller 160 determines whether there is a schedule to be currently informed. If at (901) the controller 16 determines that the current time is the alarm time, then at (902) controller 160 controls a speaker SPK to alarm. As shown in FIGS. 6 and (903) in FIG. 9, the controller 160 controls the display unit 130 to display an alarm screen including a re-alarm icon 620 and an end icon 610. When the user taps the re-alarm icon 620 as a response to an alarm, then at (904) the touch screen 110 transfers a corresponding touch event to the controller 160. Accordingly, at (905) the controller 160 controls the speaker SPK to pause the alarm. Further, the controller 160 controls the display unit 130 to eliminate an alarm screen. Further, after a preset time has elapsed, at (905) the controller 160 controls the speaker SPK to re-alarm and returns to step (903). Conversely, if the user taps an end icon 610 as a response to the alarm at (904), the touch screen 110 transfers a touch event associated therewith to the controller 160. Accordingly, the controller 160 terminates the alarm and controls the display unit 130 to eliminate an alarm screen. The number of times of alarms in the schedule may be previously set. In this schedule, the controller 160 counts the number of times of alarms in the schedule. If the counted number of times of alarms in the schedule becomes a preset value, the controller 160 automatically terminates the alarm. Such a set value may be controlled by the user. Re-alarm of the schedule may be previously set. In a case of the schedule, if the user does not respond to the alarm for a predetermined time, the controller 160 controls the speaker SPK to pause the alarm. The controller 160 controls the display unit 130 to eliminate an alarm screen. If the preset time lapses, the controller may control the speaker SPK to re-alarm.

A schedule managing method and an apparatus thereof according to the present invention provides an icon capable of setting a deadline together with deadline information when displaying a schedule such that the user may easily set a deadline of a schedule.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, thumbnail, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although a schedule managing method and an apparatus thereof according to exemplary embodiments of the present invention have been described in detail hereinabove, it should be clearly understood that many variations and modifications of the basic inventive concepts taught herein which may appear to those skilled in the present art will still fall within the spirit and scope of the present invention, as defined in the appended claims.

What is claimed is:

1. A schedule managing method comprising:
displaying by a display a deadline setting icon for setting a deadline of at least one schedule;
detecting by a controller a selection of the deadline setting icon; and
setting by the controller the deadline of the at least one schedule to a time corresponding to the deadline setting icon in response to detecting the selection of the deadline setting icon.

2. The method of claim 1, wherein displaying a deadline setting icon comprises at least one of:
displaying an icon that when selected signals the controller to change the deadline of the schedule when the deadline of the schedule was previously set; and
displaying an icon that when selected signals the controller to determine the deadline of the schedule when the deadline of the schedule has not been set.

3. The method of claim 2, wherein displaying an icon for changing the deadline of the schedule comprises:
displaying an icon that when selected signals the controller to extend the deadline of the schedule when the deadline of the schedule is identical with a current time point; and
displaying an icon that when selected signals the controller to delay or advancing the deadline of the schedule when the deadline of the schedule differs from the current time point.

4. The method of claim 1, further comprising guiding by the controller an extended or shortened deadline when the deadline of the schedule is extended or shortened by the display sensing a number of contacts of the display screen being greater than a preset number of times configured for sensing when selection of the deadline setting icon has occurred.

5. The method of claim 4, further comprising displaying by the display the schedule being extended by the number of contacts of the display screen being greater than the preset number of times distinguished from the schedule shortened by greater than the preset number of times.

6. The method of claim 1, wherein sensing selection of the deadline setting icon comprises sensing selection of the deadline setting icon in response to a touch event associated with the deadline setting icon input from a touch screen.

7. The method of claim 1, wherein setting the deadline of the schedule by the controller comprises at least one:
changing the deadline of the schedule when the deadline of the schedule is set; and
determining the deadline of the schedule as a current time point when the deadline of the schedule is not set.

8. The method of claim 7, wherein changing the deadline of the schedule comprises:
extending by the controller the deadline of the schedule when the deadline of the schedule is identical with the current time point; and
delaying or advancing the deadline of the schedule by the controller when the deadline of the schedule differs from the current time point.

9. The method of claim 1, wherein setting the deadline of the schedule by the controller comprises extending or advancing the deadline of the schedule by the number of taps input from a touch screen.

10. The method of claim 1, wherein displaying a deadline setting icon comprises:
checking whether there is a schedule to be alarmed at least with respect to a certain time, day or date in the schedule list; and
displaying by the display the schedule to be alarmed, a deadline of the schedule to be alarmed, and an icon for setting the deadline of the schedule to be alarmed there is the schedule to be alarmed in the schedule list as the checked result.

11. The method of claim 1, wherein displaying a deadline setting icon comprises:
displaying a first schedule list of scheduled items and a second schedule list of scheduled items each having respectively different deadlines from each other; and
moving display of a scheduled item corresponding to a deadline setting icon included in the first schedule list to the second schedule list and displaying the moved scheduled item when the deadline setting icon included in the first schedule list is selected by a user.

12. The method of claim 1, further comprising the controller alarming a schedule to actuate a speaker when the schedule is included in a schedule list; and
displaying an alarm screen including a first icon for terminating the alarm, and a second icon for re-alarming the schedule after a preset time.

13. The method of claim 12, wherein the alarm screen comprises a third icon for setting a deadline of the alarmed schedule.

14. A schedule managing apparatus comprising:
a display unit that displays a deadline setting icon for setting a deadline of at least one schedule;
a touch screen that generates a touch event related to a selection of the deadline setting icon displayed by the display unit; and
a controller that sets the deadline of the schedule to a time corresponding to the deadline setting icon in response to generating the touch event.

15. The apparatus of claim 14, wherein the controller changes the deadline of the schedule when the deadline of the schedule has been previously set; and the controller determines the deadline of the schedule as a current time point when the deadline of the schedule is not set.

16. The apparatus of claim 15, wherein the controller extends the deadline of the schedule when the set deadline of the schedule is identical to the current time point; and
delays or advances the deadline of the schedule when the deadline of the schedule differs from the current time point.

17. The apparatus of claim 14, wherein the controller controls the display unit to guide an extended or shortened deadline when the deadline of the schedule is extended or shortened by a number of contact selections of the deadline setting icon being greater than a preset number of times.

18. The apparatus of claim 14, wherein the controller delays or advances the deadline of the schedule by the number of the contact selections of the deadline setting icon input from the touch screen.

19. The apparatus of claim 14, wherein the display unit displays an alarm screen including a first icon for determining an alarm and a second icon for re-setting the alarm after a preset time.

20. The apparatus of claim 19, wherein the display unit displays the alarm screen including a third icon for setting a deadline of the alarmed schedule.
